(19) United States
(12) Patent Application Publication
(10) Pub. No.: US 2016/0054253 A1
(43) Pub. Date: Feb. 25, 2016

(54) Carbon-Sulfur Based Core-Shell Materials Compositions, Methods, and Applications

(71) Applicant: CORNELL UNIVERSITY, Ithaca, NY (US)

(72) Inventors: Weidong Zhou, Ithaca, NY (US); Héctor D. Abruña, Ithaca, NY (US); Hao Chen, Ithaca, NY (US); Yingchao Yu, Ithaca, NY (US)

(73) Assignee: CORNELL UNIVERSITY, Ithaca, NY (US)

(21) Appl. No.: 14/783,920

(22) PCT Filed: Apr. 11, 2014
(86) PCT No.: PCT/US14/33774

§ 371 Date: Oct. 12, 2015

Related U.S. Application Data
(60) Provisional application No. 61/811,371, filed on Apr. 12, 2013.

(51) Int. Cl. G01N 27/30; H01M 10/052; H01G 11/36; H01M 4/36

(52) U.S. Cl. CPC G01N 27/308; H01M 4/366; H01M 10/052; H01G 11/36

(57) ABSTRACT

A materials composition and a method for preparing the materials composition provide: (1) a core material comprising a reactive carbon material-sulfur material composite; surrounded by and chemically coupled with (2) a shell material comprising a reactive sheath material. The material composition is useful within electrodes within electrical components including but not limited to electrochemical gas cells, supercapacitors and batteries where enhanced cycling may be realized.

### CROSS-REFERENCE TO RELATED APPLICATIONS

This application is related to, and derives priority from, U.S. Provisional Patent Application Ser. No. 61/811,371, filed 12 Apr. 2013 and titled Battery Apparatus, Methods and Applications, the content of which is incorporated herein fully by reference.

### STATEMENT OF GOVERNMENT INTEREST

The research that lead to the embodiments as described herein, and the invention as claimed herein, was supported by the United States Department of Energy through grant number DE-FG02-87ER45298, in support of the Energy Materials Center at Cornell (EMC2), an Energy Frontier Research Center funded by the United States Department of Energy, Office of Basic Energy Sciences under Award Number DE-SC0001086. This work also made use of the electron microscopy facility of the Cornell Center for Materials Research (CCMR) with support from the National Science Foundation Materials Research Science and Engineering Centers (MRSEC) program DMR 1120296. The United States government may have rights in the invention as claimed herein.

### BACKGROUND OF THE INVENTION

1. Field of the Invention

Embodiments relate generally to lithium-sulfur batteries (Li/S) and related electrical components. More particularly, embodiments relate to Li/S batteries and related electrical components with enhanced performance.

2. Description of the Related Art

There is currently a great deal of interest in the development of high energy, high power density and long life rechargeable batteries for transportation and grid applications. Lithium-sulfur (Li/S) batteries represent one of the most promising candidates for next energy storage owing to their high theoretical capacity of 1673 mAh g⁻¹, which is about five times that of current commercial lithium-ion batteries (LIB s). However, despite their attractive properties, Li/S batteries generally suffer from poor cyclability, which is mainly attributed to the dissolution of intermediate lithium polysulfide products Li₂Sₙ (4≦n≦8), volumetric expansion and the poor conductivity of sulfur and polysulfide species.

Since Li/S batteries are likely to be of continued interest within the context of energy storage and energy conversion applications, desirable are Li/S batteries, Li/S battery components and related electrical components, with enhanced performance.

### SUMMARY

The embodiments provide a materials composition, a method for preparing the materials composition, an electrode for an electrical component that includes the materials composition and the electrical component that includes the electrode that includes the materials composition. Within the context of each of the foregoing, the materials composition comprises: (1) a core material that comprises a reactive carbon material-sulfur material composite; surrounded by and chemically coupled with (2) a shell material comprising a complementary reactive sheath material. As will be seen within the context of further description and disclosure below, the materials composition in accordance with the embodiments when used within an electrode within an electrical component such as but not limited to a Li/S battery provides the electrical component such as but not limited to the Li/S battery with enhanced cyclability performance.

Within the embodiments, a “reactive carbon material” is intended as a carbon material that includes chemically reactive functionality that provides for chemical bonding and/or alternative chemical interactions between the reactive carbon material-sulfur material composite and the complementary reactive sheath material. For example and without limitation, such chemically reactive functionality may include, but is not necessarily limited to hydroxyl functionality and carboxylic acid functionality (which is intended to include carboxylate functionality). Within the embodiments a reactive carbon material may comprise as a base material a carbon material selected from the group including but not limited to amorphous carbon materials, crystalline carbon materials and graphitic carbon materials, any of which is suitably derivatized with a suitable chemical functionality to thus provide the reactive carbon material.

Within the embodiments, a “sulfur material” is intended as a sulfur material that typically does not include any chemically reactive functionality.

Within the embodiments, a “reactive carbon material-sulfur material composite” core material may result from physical mixing and thermal annealing of the reactive carbon material with the sulfur material that typically includes no chemically reactive functionality. The embodiments as described below consider a plurality of methods for preparing a reactive carbon material-sulfur material composite.

Within the embodiments a “complementary reactive sheath material” that comprises the shell material is intended as a polymer material that includes complementary chemically reactive functionality with respect to the reactive carbon material, so that the core material and the shell material in accordance with the embodiments may chemically couple when the core material is surrounded by the shell material. Such chemical coupling may include, but is not necessarily limited to ionic bonding, covalent bonding and hydrogen bonding, as well as chemical bonding circumstances that involve at least two of ionic bonding, covalent bonding and hydrogen bonding. Alternative chemical bonding circumstances and scenarios are not precluded.

The embodiments are thus predicated in-part upon an interaction between a reactive carbon material and a sulfur material when forming a reactive carbon material-sulfur material composite core material. As well, the embodiments are also predicated in-part upon a chemical coupling reaction between a reactive carbon material-sulfur material composite core material and a shell material that comprises a complementary reactive sheath material.

As is understood by a person skilled in the art, the foregoing chemical coupling reaction between the reactive carbon material-sulfur material composite and the complementary reactive sheath material is intended as possibly being identified using spectroscopic evaluation apparatus as are otherwise generally conventional in the art. As such, the embodiments intend that the chemical coupling reaction between the reactive carbon material-sulfur material composite and the complementary sheath material is distinguishable from a binder material presence which in turn does not typically have any measurable interaction.

For general comparison in accordance with the embodiments, a “graphite” material is intended as a pure carbon hexagonally structured conductive carbon multi-sheet material in comparison with which a “graphene” material is a single sheet of the foregoing multi-sheet material. For further general comparison in accordance with the embodiments, a “graphene oxide” material or a “graphite oxide” material is intended as a graphene material or a graphite material that further includes chemically reactive functionality that further in turn provides for chemical coupling. Thus a “graphene oxide” material or a “graphite oxide” material is as is understood by a person skilled in the art a reactive carbon material as described above.

A particular method for preparing a material composition in accordance with the embodiments includes combining a reactive carbon material and a sulfur material to form a reactive carbon material-sulfur material composite core material. The particular method also includes combining the reactive carbon material-sulfur material composite core material with a complementary reactive sheath material to provide a reactive carbon material-sulfur material composite core material surrounded by and chemically coupled with the complementary reactive sheath material as a shell material.

A particular materials composition in accordance with the embodiments includes a core material comprising a reactive carbon material-sulfur material composite. The particular materials composition also includes a shell material comprising a complementary reactive sheath material that surrounds and is chemically coupled with the core material.

A particular electrode in accordance with the embodiments includes: (1) a conductive substrate; and (2) a material composition located upon the conductive substrate. Within the particular electrode, the material composition includes: (1) a core material comprising a reactive carbon material-sulfur material composite; and (2) a shell material comprising a complementary reactive sheath material that surrounds and is chemically coupled with the core material.

A particular electrical component in accordance with the embodiments includes an electrode that includes: (1) a conductive substrate; and (2) a material composition located upon the conductive substrate. Within the particular electrical component, the material composition includes: (1) a core material comprising a reactive carbon material-sulfur material composite; and (2) a shell material surrounding the core material and comprising a complementary reactive sheath material chemically coupled to the reactive carbon material.

### BRIEF DESCRIPTION OF THE DRAWINGS

The objects, features and advantages of the embodiments are understood within the context of the Detailed Description of the Non-Limiting Embodiments, as set forth below. The Detailed Description of the Non-Limiting Embodiments is understood within the context of the accompanying drawings, that form a material part of this disclosure wherein:

FIG. 1 shows a thermogravimetric analysis (TGA) curve of a sulfur-amylopectin-carbon black composite recorded in argon with a heating rate of 5° C. min⁻¹ and TGA of amylopectin-carbon black (with the ratio of 15:25) was also measured as a control experiment.

FIG. 2 shows a typical CV of sulfur-starch cathode at a sweep rate of 0.05 mV s⁻¹

FIG. 3 shows: (a) charge/discharge profiles; and b) charge/discharge capacities vs cycle number for S-Amy cathode at a rate of C/8. 1 C corresponded to a current density of 1600 mA/g and the capacity values were calculated based on the mass of sulfur.

FIG. 4 shows a schematic of a two step synthesis route for a GO-S-Amy composite, with yellow balls (i.e., white in gray scale) representing sulfur and black balls representing carbon black.

FIG. 5 shows TGA curves of GO and GO-S composite recorded in argon with a heating rate of 50 C min⁻¹. From the TGA result, it is clear that the mass loss of GO is around 35%, which should be due to the loss upon heating. As shown above, the weight loss of GO-S at this condition is of functional groups in GO around 82%. Therefore, the sulfur content in the GO-S composite is around [(82-35)/65]=0.723.

FIG. 6 shows TGA curves of GO-S-Amy composite recorded in argon with a heating rate of 50 C min⁻¹. From the TGA result, it is clear that the total weight loss is around 76%, including 13% contribution from the amylopectin. So, the sulfur content in GO-S-Amy composite should be around [(76-13)/82]*0.723=0.55. The final sulfur content in the whole electrode was around 52% accounting 5% PTFE binder added during the preparation of the electrode film.

FIG. 7 shows SEM images of GO (a) and GO-S-Amy (b) composite.

FIG. 8 shows STEM images of GO-S-Amy in bright field (a) and dark field (b). Elemental mapping of the region shown in yellow square of (b) for carbon (c), sulfur (d) along with (e) an overlay of those two maps. (f) EDX spectrum of GO-S-Amy composite.

FIG. 9 shows STEM bright field image of the GO-S composite (a) and the corresponding elemental mapping for carbon (b), oxygen (c) and sulfur (d). (e) EDX spectrum of GO-S composite.

FIG. 10 shows: a) typical CV of GO-S-Amy cathode at a sweep rate of 0.1 mV s⁻¹; b) first cycle charge/discharge profiles for the GO-S-Amy cathodes at current densities of C/8, 5 C/16 and C/2; c) and d) charge/discharge capacities vs cycle numbers of GO-S and GO-S-Amy at different current densities.

FIG. 11 shows a) first cycle charge/discharge profiles for the GO-S-Amy cathodes with the sulfur loadings of 2 mg cm⁻² and 6 mg cm⁻² at C/8; b) charge/discharge capacities vs cycle numbers of GO-S-Amy at different sulfur loadings.

FIG. 12 shows STEM dark field image of GO-S-Amy composite after 50^{th} discharge in cell (a) and corresponding elemental mapping for sulfur (b) and carbon (c).

FIG. 13 shows XRD patterns of Sulfur, GO and GO-S-Amy relative to GO, the disappearance of the broad diffraction peak at 430 in GO-S-Amy indicated the GO surface was cover with sulfur and amylopectin.

FIG. 14 shows the coulombic efficiency of GO-S-Amy electrodes with different sulfur loadings at a C rate of C/8.

FIG. 15 shows EDX spectrum of GO-S-Amy composite (after 50th discharge) measured in STEM. The aluminum signal is from the current collector.

FIG. 16 shows FTIR spectra of GO, GO-S-Amy composite and GO-S-Amy (after 50th discharge).

### DETAILED DESCRIPTION OF THE NON-LIMITING EMBODIMENTS

The embodiments provide a materials composition, a method for preparing the materials composition, an electrode for an electrical component that includes the materials composition and the electrical component that includes the electrode that includes the materials composition. Within the context of each of the foregoing, the materials composition comprises a reactive carbon material-sulfur material composite core material surrounded by and chemically coupled with a complementary reactive sheath material as a shell material. As will be seen within the context of further description and disclosure below, the materials composition when used within an electrode within a Li/S battery provides the Li/S battery with enhanced cyclability uniformity.

### 1. GENERAL CONSIDERATIONS REGARDING REACTIVE CARBON-SULFUR CORE/SHELL MATERIAL COMPOSITIONS

While the embodiment that follows describes the invention within the context of a graphene oxide reactive carbon material in a composite with an elemental sulfur material to provide a reactive carbon material-sulfur material composite core material that is surrounded by and chemically coupled with an amylopectin complementary reactive sheath material shell material, the embodiments are not intended to be so limited. Rather, the embodiments consider in general a reactive carbon material that is in a composite with a sulfur material to provide a reactive carbon material-sulfur material composite core material and further surrounded by and chemically coupled with a complementary reactive material sheath material that comprises a shell material.

Within these more general embodiments the reactive carbon material may be selected from the group including but not limited to chemically functional amorphous carbon materials, chemically functional crystalline carbon materials and chemically functional graphitic carbon materials.

Non-limiting examples of the foregoing reactive carbon materials may comprise graphite, graphene, graphene oxide, amorphous carbon, carbon black and carbon-tubes, etc., given a suitable chemically reactive functionality. Within these more general embodiments the sulfur material may be selected from the group including but not limited to elemental sulfur materials and sulfide materials. Within these more general embodiments, the complementary reactive sheath material shell material may be selected from the group including but not limited to polysaccharides in general including amylopectin in particular, polyethylene glycol materials and related polyhydroxy polymer materials, polycarboxyllic acid polymer materials including polycarboxylate polymer materials, and polyamide polymer materials.

Within the context of the embodiments, typically, the reactive carbon material and the sulfur material are present in a weight ratio from about 1:10 to about 2:1. Within the embodiments the reactive carbon material and the sulfur material may be thermally annealed to form a composite at a temperature from about 100 to about 600 degrees centigrade for a time period from about 2 minutes to about 10 hours.

Within the context of the embodiments, the complementary reactive sheath material comprises a base polymer material having a molecular weight from about 500 to about 100,000 amu and at least one chemically reactive functional group per polymer repeating unit. The reactive carbon material-sulfur material composite core material in accordance with the embodiments is surrounded by and chemically coupled with the complementary reactive sheath material as a shell material at a temperature from about −10 to about 100 degrees centigrade within the context of solution absorption. Such a solution absorption may utilize any of several solvents as are conventional in the art, which will generally comprise water based solvents, as well as organic solvents.

Within the context of the embodiments, core-shell (i.e., reactive carbon material-sulfur material core material and complementary reactive sheath material shell material) materials compositions are useful within electrodes within electrical components including but not limited to electrochemical gas cells, supercapacitors and in particular within batteries such as but not limited to Li/S batteries, where enhanced cycling may be realized.

### 2. SPECIFIC EMBODIMENT INCLUDING GRAPHENE OXIDE-SULFUR-AMYLOPECTIN (GO-S-AMY)

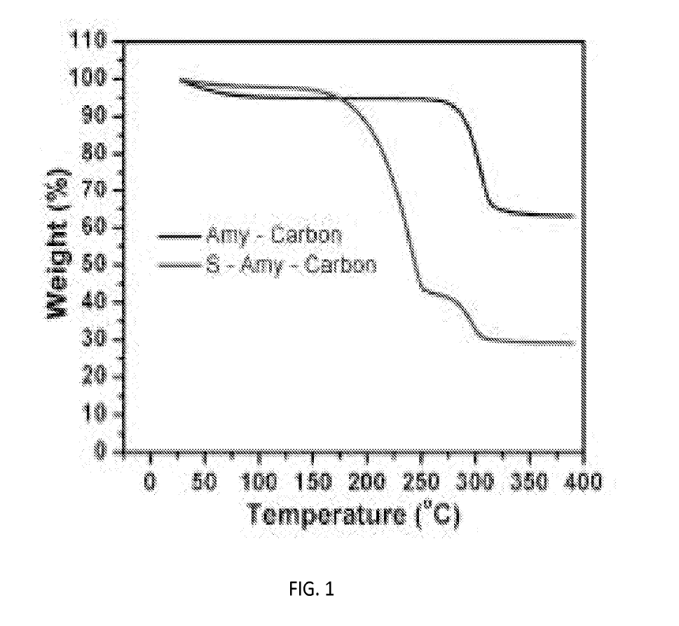

A control sample of amylopectin doped sulfur without GO (but which contained carbon black) was first prepared to test electrochemical properties. Sulfur and carbon black were first heated to 155° C. for 12 hours to obtain a homogeneously mixed material. The mixture was dispersed in an aqueous amylopectin solution under sonication and excess ethanol was then added slowly to yield the black precipitation of amylopectin coated sulfur (S-Amy) composite. According to the thermogravimetric analysis (TGA) curve of the obtained black powder, in FIG. 1, around 56% sulfur and 14% amylopectin were contained in the composite. It was then ground in the presence of 5% polytetrafluoroethylene (PTFE) to lower the stiffness of amylopectin, giving the electrode films an average sulfur mass loading of 4.0 mg cm⁻². Coin cells were fabricated to test the electrochemical performance of the S-Amy composite using lithium foil as the anode and 1.0M lithium bis-trifluoromethanesulfonylimide (LiTFSI) in a mixed solvent of 1,3-dioxolane and 1,2-dimethoxyethane (1:1, v/v) with or without the presence of LiNO₃ additive as the electrolyte.

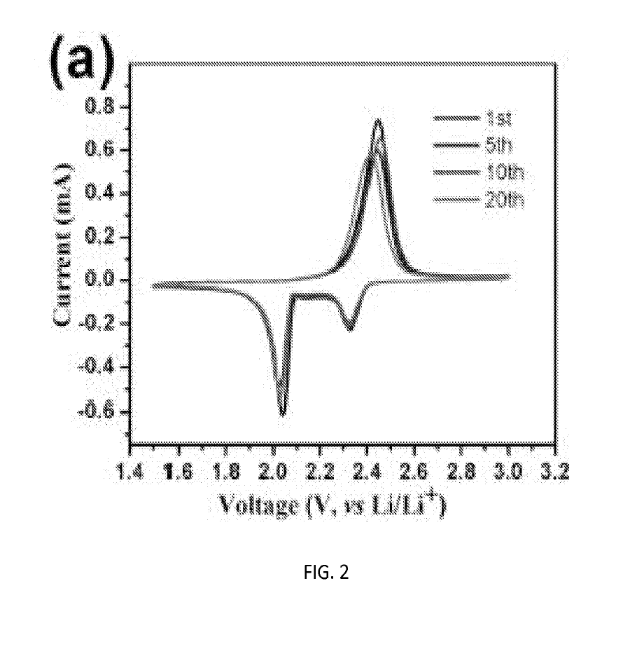

A cyclic voltammetry (CV) of a Li/S cell with the S-Amy cathode was obtained at a scan rate of 0.05 mV s⁻¹, and is shown in FIG. 2. Two well-defined reduction peaks at 2.35 and 2.08V were observed, which could be assigned to the multistep reduction mechanism of elemental sulfur, as reported previously. The reduction peak centered around 2.35V is generally attributed to the reduction of the S₈ ring and the formation of S₈²⁻. The reduction peak at 2.08V is associated with further reduction of the higher polysulfide species (Li₂Sₙ, 4<n<8) to the lower polysulfide species (Li₂Sₙ, n≦2). The broad oxidation peak around 2.3-2.5V is associated with the oxidation of polysulfides to the neutral elemental S₈.

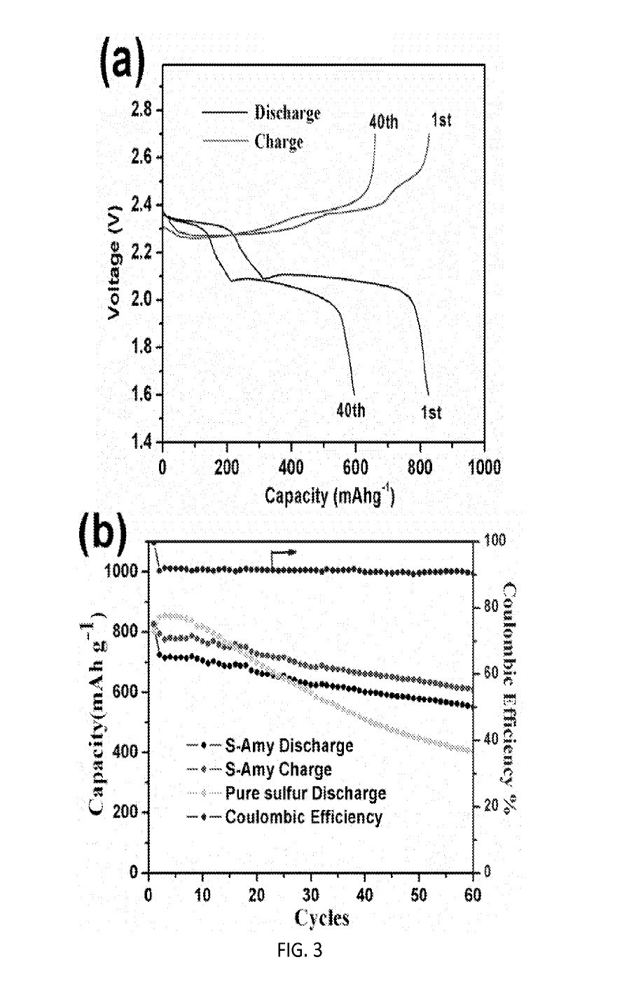

FIG. 3a depicts the first and 40th discharge/charge profiles of the S-Amy electrode at a rate of C/8 in a rechargeable lithium cell. Two flat discharge plateaus located at 2.35 and 2.08V were clearly observed, in good agreement with the CV results. As shown in FIG. 3b, the S-Amy electrode showed an initial discharge capacity of 825 mAh g⁻¹ followed by a gradual decrease during subsequent cycles. Compared with the cycling performance of the pure sulfur electrode, although the pure sulfur cathode exhibited a higher capacity in initial 15 cycles, it exhibited a much faster capacity fade especially after 30 cycles. The relatively slow capacity fading of S-Amy electrode indicates that the addition of amylopectin can alleviate the diffusion of the lithium polysulfides into the electrolyte and therefore suggests that the amylopectin could be adopted as an additive for Li/S batteries. On the other hand, the coulombic efficiency of the S-Amy electrode stabilized at a little over than 90% and the capacity still faded obviously, which indicate there still be some polysulfide dissolution and shuttling of the polysulfide species.

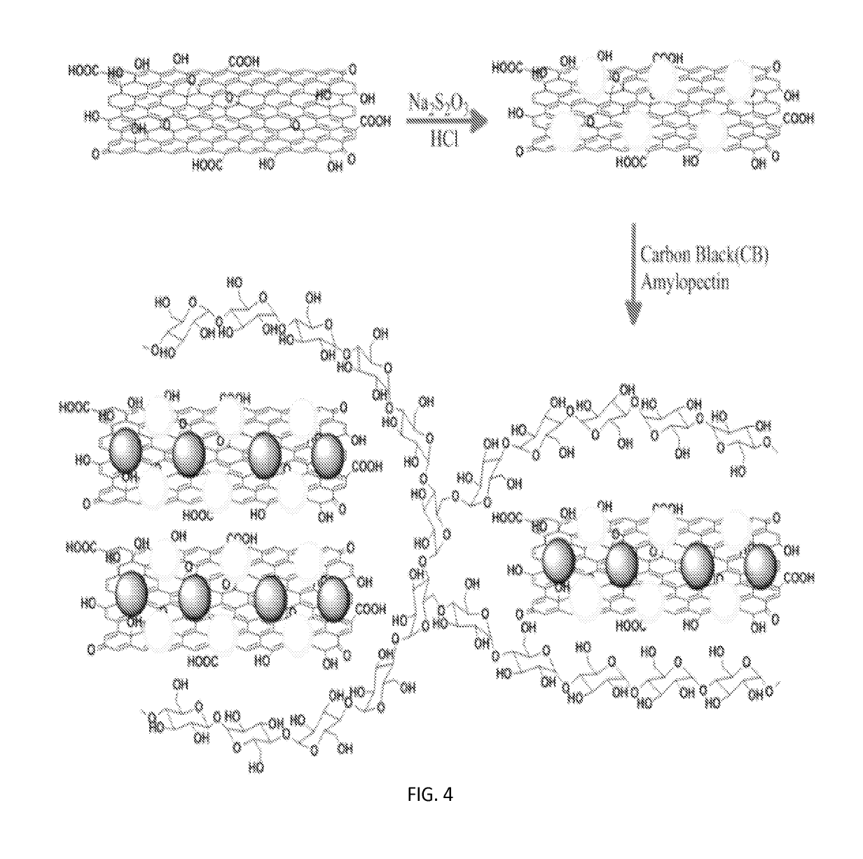

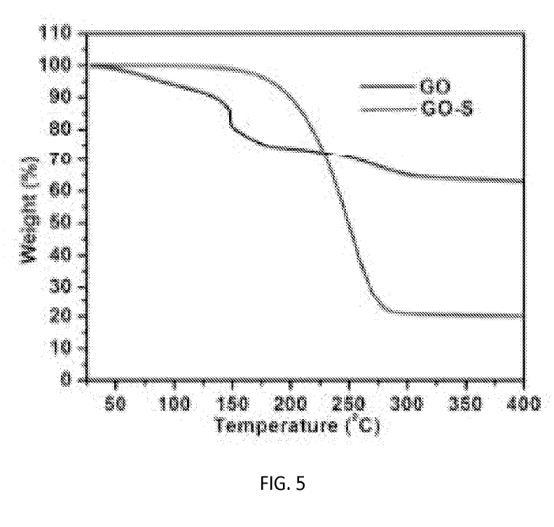

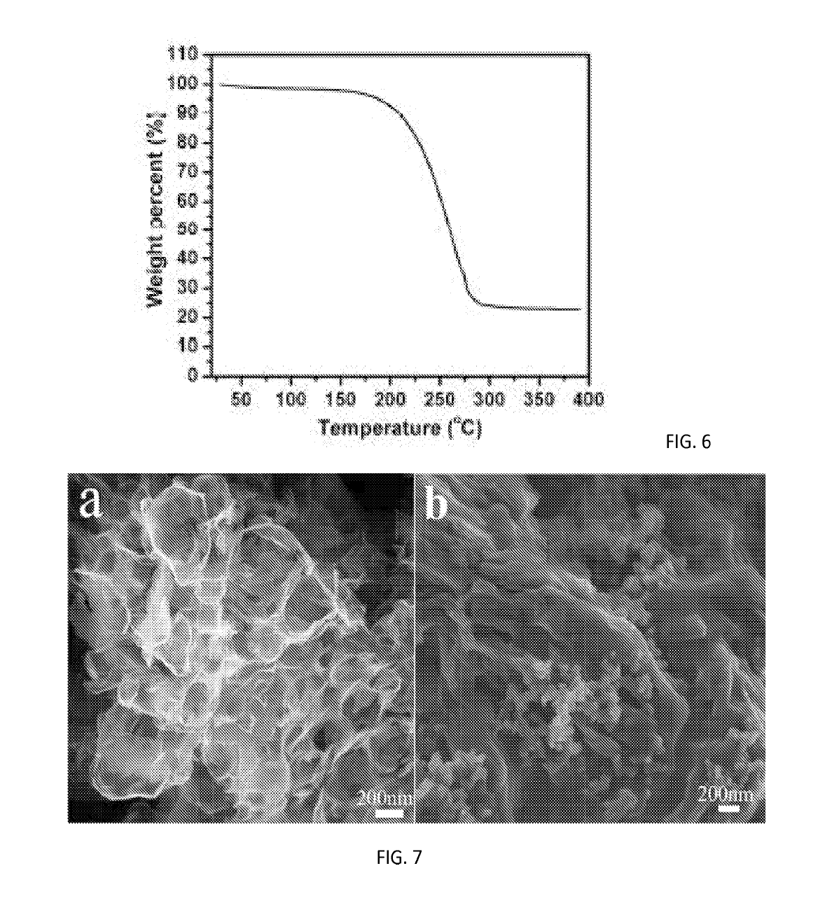

The amylopectin wrapped graphene oxide-sulfur (GO-S-Amy) composite was subsequently prepared through a quite simple dissolution-precipitation method. In the approach FIG. 4, typical Hummers GO (i.e., GO prepared through oxidation of graphite using the KMnO₄ and NaNO₃ in H₂SO₄ was employed in the electrode composite. The GO was first dispersed in a solution of sodium thiosulfate under sonication to form a homogenous suspension. Sulfur particles could then be synthesized and precipitated homogeneously among GO layers by reacting sodium thiosulfate with hydrochloric acid. As shown in the TGA curve of FIG. 5, around 72 wt % of sulfur was incorporated in the GO-S composite. The as prepared GO-S and carbon black were dispersed in an aqueous solution of amylopectin through sonication. Excess ethanol was then slowly added to give the GO-S-Amy floccus precipitation, which was employed to make the electrode film after drying in vacuum. According to the TGA results of FIG. 6, the final sulfur content in the whole electrode was around 52% accounting 5% PTFE binder added during the preparation of the electrode film. This approach is much simpler and economical when compared with the widely used procedure of long time or repeated sublimation for infusion of elemental sulfur into porous carbons. Also, such a process is environmentally benign and highly reproducible, and can be straightforward to scale up in industry.

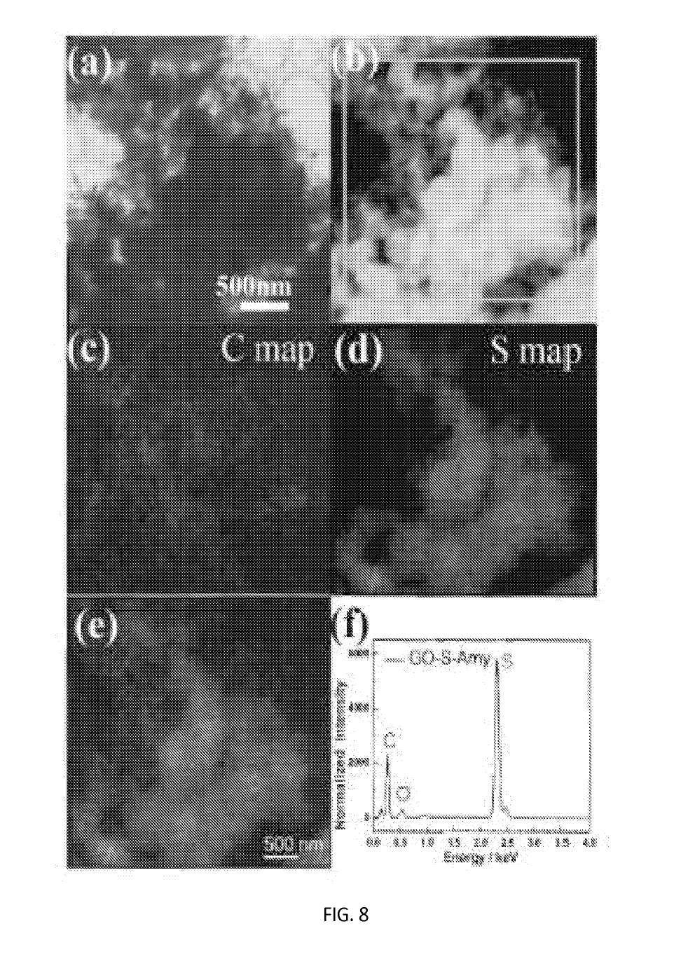

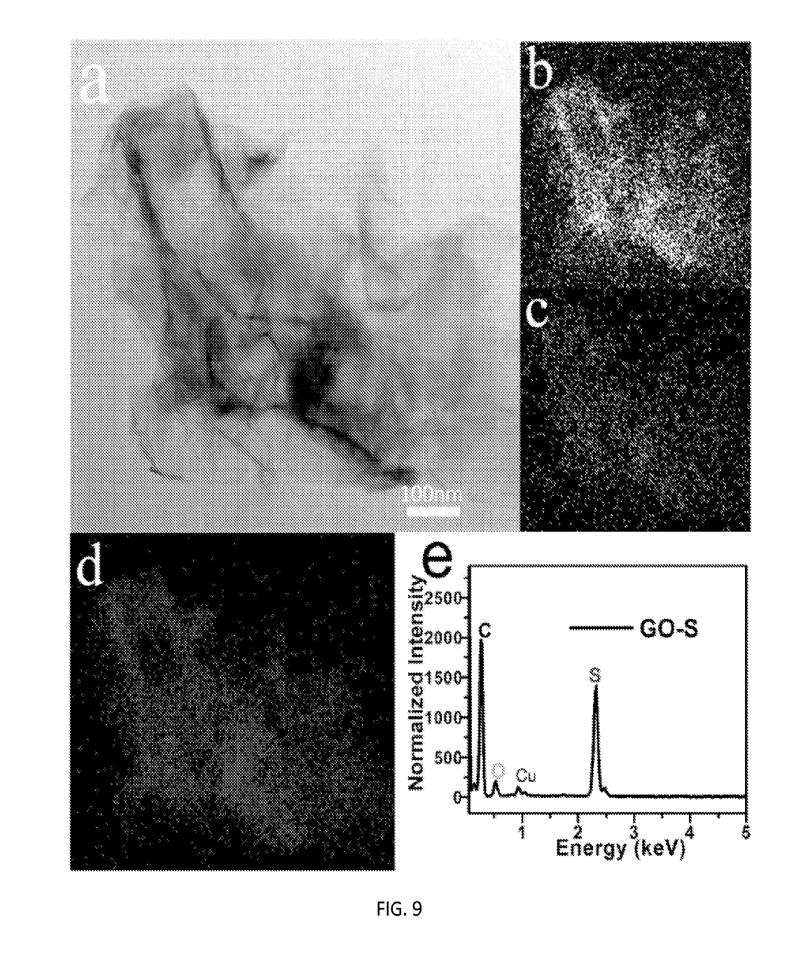

FIG. 7 exhibits the scanning electron microscopy (SEM) images of the GO and GO-S-Amy composite. Compared with the well defined flake structure of GO, amorphous and aggregated nano-sheets with carbon black particles on the surface were observed for the GO-S-Amy composite, which could be attributed to the interaction between amylopectin and GO. In the scanning transmission electron microscopy (STEM) images of GO-S-Amy composite, sulfur particles with a diameter of around 500 nm could be clearly observed, as shown in FIG. 8a. Elemental maps of sulfur and carbon confirmed that the bright particles in FIG. 8b were sulfur particles, along with overlaying carbon signals from GO sheets. Compared with the SEM image of FIG. 7b, the sulfur particles should have been confined among the GO layers, because there was no sulfur particle that could be observed on the surface from the SEM image. Energy-dispersive X-ray (EDX) microanalysis exhibited strong sulfur peak, which is around three times of carbon, as shown in FIG. 8f. The relative content of sulfur in GO-S-Amy should be higher considering that the contribution of amylopectin and the carbon film on the STEM grid was also included in the EDX intensity of carbon. In the case of unwrapped GO-S, the sulfur particles could not be observed in the STEM images, as shown in FIG. 9, which can be attributed to the high vacuum of STEM and high vapor pressure of the sulfur. Although elemental sulfur could still be detected in the sulfur map, the EDX intensity of sulfur is obviously smaller compared with the carbon, which suggests most of the sulfur in GO-S was evaporated in the high vacuum of STEM. These features, from one side, verify the amylopectin effectively wrapped the sulfur in GO-S-Amy.

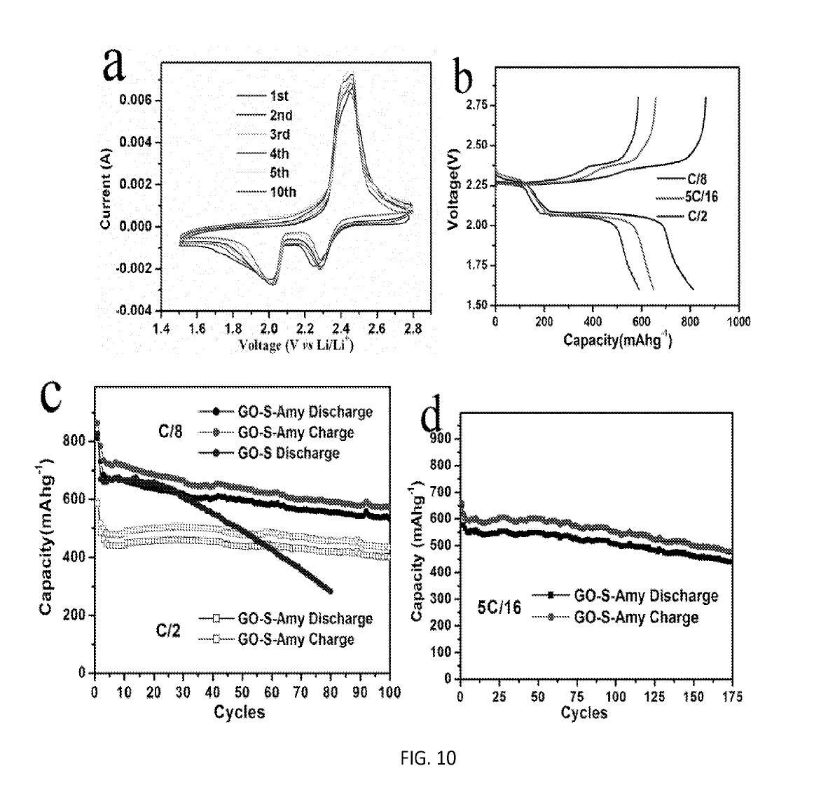

The obtained dry GO-S-Amy composite was employed to make the electrode films with several typical sulfur mass loadings of 2.0 mg cm⁻², 4.0 mg cm⁻² and 6.0 mg cm⁻² through control of the thickness of electrode films. FIG. 10 shows the CV and cycling performance of coin cells using GO-S-Amy as the cathode with a sulfur loading of 4.0 mg cm⁻². Two well defined reduction peaks centered around 2.3 and 2.03V were clearly observed, similar to the CV of the S-Amy electrode described above. During the initial 10 cycles, the redox curves become sharper gradually suggesting reversibility actually improved with cycling. As illustrated in FIG. 10, the GO-S-Amy electrodes showed initial capacities of 817, 650 and 596 mAh g⁻¹ under different C rates of C/8, 5 C/16 and C/2, respectively. Although there was an initial drop, the capacity stabilized after about 5 cycles at both low and high current densities, as observed in FIG. 10c. Afterward, there was a much more gradual decrease in capacity. A control sample of GO-S without amylopectin coating exhibited a stable cyclability during the first 25 cycles followed by a significant capacity fading. Relative to the amylopectin free GO-S electrode, the GO-S-Amy electrode exhibited much improved capacity retention with long cycling, which was ascribed to the cross-linked structures of GO wrapped amylopectin and polysulfides. After a long-term cycling of 175 cycles, a discharge capacity of 441 mAh g⁻¹ was obtained at 5 C/16, which corresponded to a 68% capacity retention ratio as shown in FIG. 10d. At the higher current density of C/2, much more stable cycling performance was observed with a stable capacity around 430 mAh g⁻¹, which did not decay significantly after 100 cycles. The relatively better cycling performance at C/2 can be attributed to the weaker shuttle effect at higher current density. The improved cycling stability verifies the fact that amylopectin wrapped GO-sulfur structure can help to immobilize the polysulfides and reduce the capacity fading, which was in agreement with the successful confinement of sulfur under high vacuum of STEM. The branched amylopectin could wrap and bind GO layers effectively through its cross-linked 3-dimension structure and supramolecular interaction, which closes the open channels among GO layers and minimizes the diffusion of the polysulfides. As a result, electrodes employing the amylopectin wrapped GO-Sulfur exhibited better cycling stability.

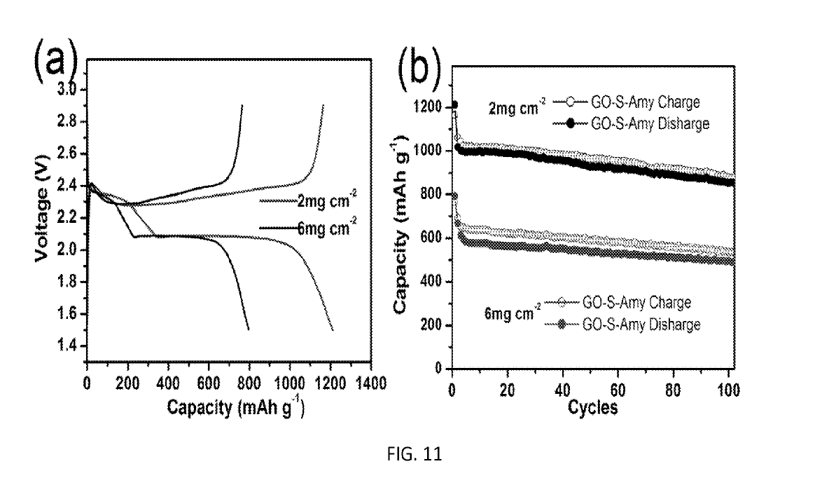

FIG. 11 shows the CV and cycling performance of the GO-S-Amy composite electrodes with different sulfur loadings of 2 mg cm⁻² and 6 mg cm⁻² at C/8. Obviously, the lower sulfur loading of 2 mg cm⁻² GO-S-Amy cathode delivered higher discharge capacity and efficiency in this condition. From the FIG. 11, the coulombic efficiencies of the electrode with different sulfur loadings of 2 mg cm⁻², 4 mg cm⁻² and 6 mg cm⁻² at C/8 were around 98, 94 and 91, respectively. Here, lower capacity at higher sulfur loading can be attributed to the poorer ionic transportation and contact in thicker electrode film. One should point out that although this composite showed better cycling stability compared with the pure sulfur and un-wrapped GO-S, slow capacity degradation could still be observed. Besides, the efficiency was just around 98% even in low sulfur loading of 2 mg cm⁻², which indicates that the dissolution of polysulfides and the subsequent shuttling effect are still not completely vanished in this condition. But the low cost of materials and the easy scaled up preparation process give the competitive advantage for this structure.

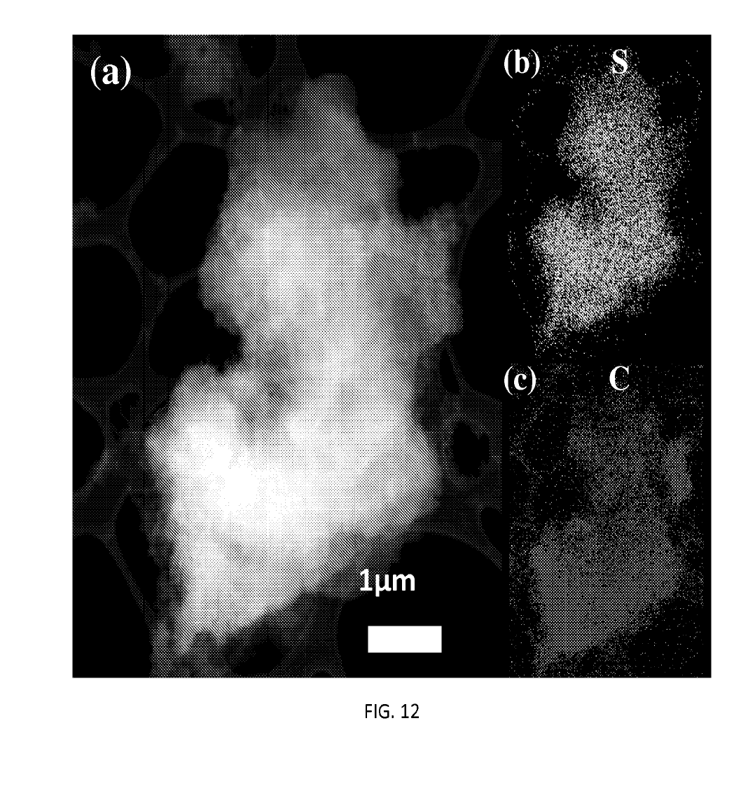

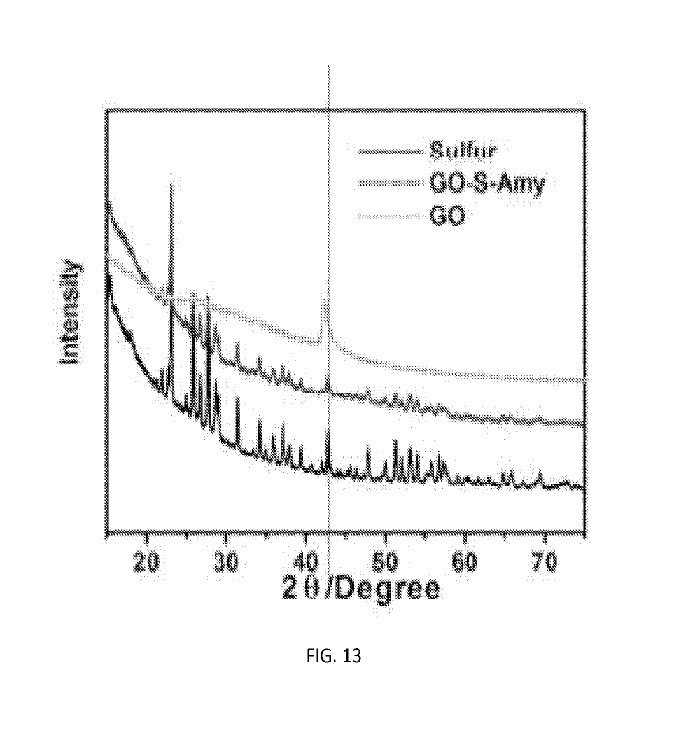

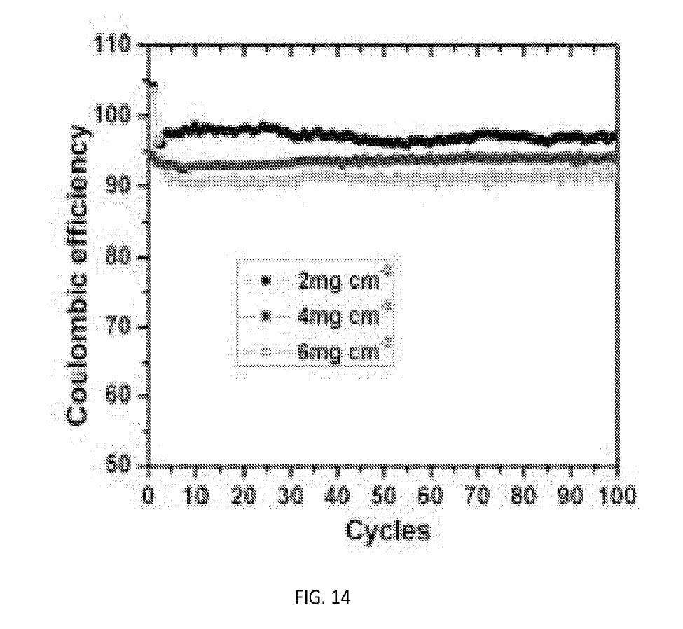

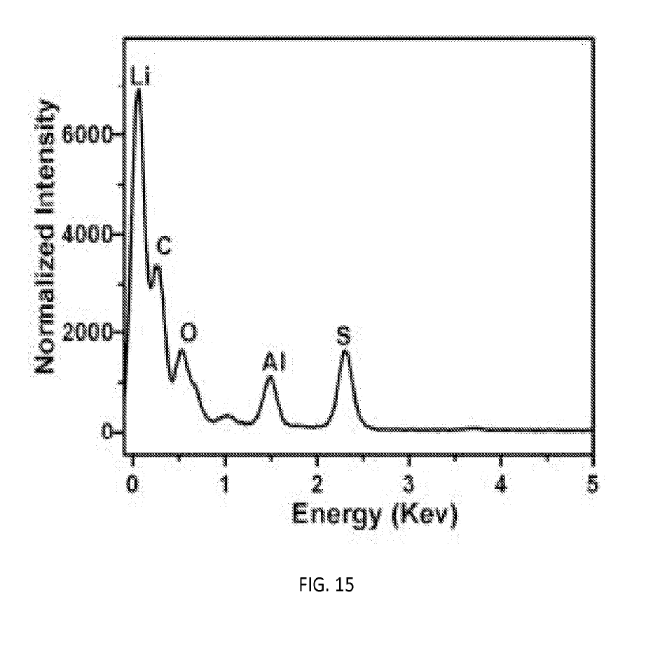

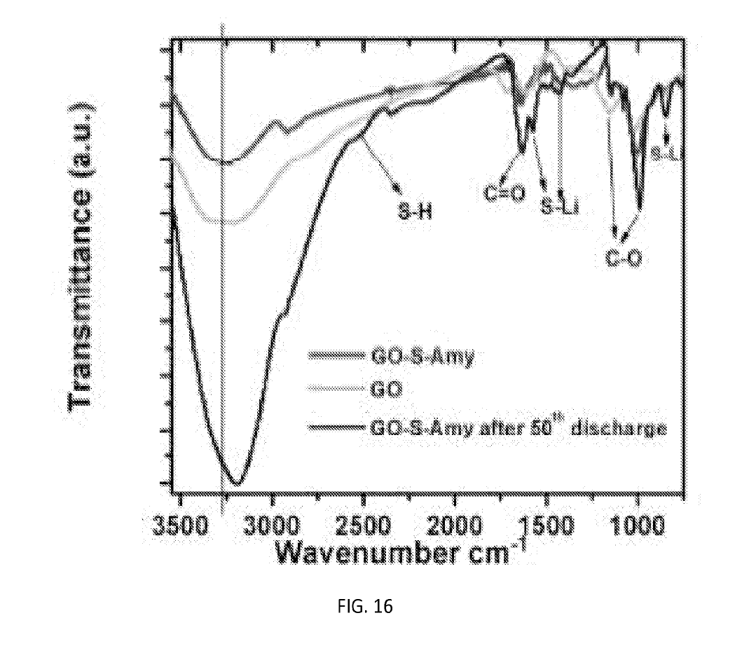

To further investigate the structure of the GO-S-Amy composite during the long cycling, a cell was opened after 50^{th} full discharge in cell and the electrode was peeled off from the current collector and re-dispersed in THF under sonication. As shown in the STEM images and EDX mapping of FIG. 12, the sulfur particles were disappeared and the elemental sulfur dispersed homogeneously among the GO layers, owning to the precipitation of a thin layer of discharge products (Li₂S₂ and/or Li₂S). It is also noticeable that the building-in of GO-S was still maintained after running 50 cycles, which indicates the stability of this structure. Various other characteristics of the GO-S-Amy composite are illustrated in FIG. 13, FIG. 14 and FIG. 15 and described in some detail within the Brief Description of the Drawings. The Fourier transform infrared spectroscopy (FTIR) spectra of the 50^{th} discharged cathode exhibited obvious peaks at 1580 cm⁻¹, 1426 cm⁻¹ and 850 cm⁻¹, as shown in the FIG. 16, suggesting the formation of S—Li or O—Li. The summit of broad band between 3600 and 2600 cm⁻¹ resulting from the O—H groups of GO-S-Amy (after 50^{th} discharge) shifted towards short wavenumber compared with the GO-S-Amy, which indicates the presence of the hydrogen bonds in discharged GO-S-Amy composite. Meanwhile, an obvious shoulder at 2535 cm⁻¹ could be ascribed to the S—H stretching vibration, which suggested the presence of the balance between O—H and S—H. These observations, including the STEM and FTIR, suggest that the GO-S-Amy composite forms a stable cross-linked structure through the supramolecular interactions, which can accommodate the charge/discharge reactions and preserve the structure in long cycling.

### 3. CONCLUSION

In conclusion, a natural polymer, amylopectin wrapped graphene oxide-sulfur nanocomposite has been prepared and investigated for immobilizing the lithium polysulfides in the cathode of Li/S cells. With the help of this 3-dimensionally cross-linked structure, the Li/S battery exhibited much improved cycling stability and columbic efficiency compared with the conventional sulfur electrodes. From the comparison of STEM images and EDX data, the branched amylopectin successfully confined the sulfur particles among the GO layers, which helps to tether the polysulfides during the charge/discharge processes. Different sulfur loading electrodes were tested and compared as well, lower sulfur loading electrode show better capacity and efficiency relative to higher sulfur loading electrode. While slight capacity fading presents in these and premier studies, one may observe that these results provide reliable insights and novel concepts for future Li/S batteries.

### 4. EXPERIMENTAL

Preparation of S-Amy Composite Electrode

In a typical electrode making process of S-Amy, 50 mg sulfur and 25 mg carbon black were first heated at 155° C. for 12 hours to obtain a homogeneous material. The mixture was dispersed in 100 ml aqueous solution of 15 mg amylopectin under sonication and 300 ml ethanol was then added slowly to yield the precipitation of amylopectin coated sulfur-carbon black composite. The above precipitation and polytetrafluoroethylene (PTFE) were well ground in a mortar with the addition of isopropanol and then were roll-pressed to produce an electrode film, which was heated at 50° C. for 12 hours under vacuum before using to make the coin cell. The coin cells were fabricated in an argon-filled glove box using lithium metal as the counter electrode and a microporous polyethylene separator. The control experiment of pure sulfur coin cell was also fabricated according to the same procedure, except that the cathode composite was made from 50% of elemental sulfur, 40% of carbon black and 10% of PTFE binder.

Synthesis of GO-S-Amy Composite

60 mg GO was well dispersed in 100 ml water through 1 hour sonication to obtain a black homogeneous suspension. For sulfur particles synthesis, 2.0 g of Na₂S₂O₃ was first dissolved in 400 ml of 1% PVP aqueous solution. 6 ml concentrated hydrochloric acid was added to the above solution, and then the system was kept at room temperature for 40 min with magnetic stirring to get white gel solution of sulfur particles. The suspension of GO was then added into the sulfur gel solution under vigorous magnetic stirring. After 20 min, the product of GO-S was collected by centrifuge and further washed twice with water. 10 mg amylopectin was suspended in 100 ml water and then heated to 80° C. for 1 hour to get a transparent solution. Fresh prepared 70 mg of GO-S and 15 mg carbon black were added to the above solution and stirred for 30 min under sonication for intensive mixing. The resulting suspension was poured into 300 ml ethanol, filtered and dried to get a black powder. The obtained powder and 5% PTFE were well ground in a mortar with the addition of isopropanol and then were roll-pressed to produce an electrode film, which was heated at 50° C. for 12 hours under vacuum before using to fabricate the coin cell. The GO-S-Amy coin cell was fabricated according to the similar procedure as S-Amy coin cell.

Material Characterization

Powder X-ray diffraction (XRD) was performed by using a Rigaku® Ultima VI diffractometer, and diffraction patterns were collected at a scanning rate of 5°/min and with a step of 0.02°.

Electron microscopy imaging was carried out using a Schottky-field-emission-gun Tecnai F20 scanning transmission electron microscope (STEM) operated at 200 keV. A high-angle annular dark field detector provided an incoherent projection image of the specimen with a signal intensity proportional to the amount of material and its atomic number, which is also known as Z-contrast.

The energy dispersive x-ray (EDX) analysis was per-formed in F20 using an Oxford detector, at a beam current of about 1 nA. An EDX resolution of 1-5 nm is routinely achieved on this setup. Sulfur of GO-S-Amy was not found to sublime into vacuum within the electron microscope under the testing conditions, likely due to the wrapping effect of GO and amylopectin, which protects sulfur against sublimation. Coin cells were measured in an Arbin Instruments apparatus with doubled charge C rate relative to discharge C rate and the presented C rates were all based on the discharge process.

The summit of broad band between 3600 and 2600 cm⁻¹ resulting from the O—H groups of GO-S-Amy (after 50th discharge) shifted towards short wavenumber compared with the GO-S-Amy, which indicates the presence of the hydrogen bonds. The spectra of discharged cathodes reflected the obvious formation of S—Li or O—Li from the peaks at 1580 cm⁻¹, 1426 cm⁻¹ and 850 cm⁻¹. The characteristic peaks at 997 cm⁻¹ and 1142 cm⁻¹ were related to the C—O band stretching vibration. The peak at 1639 cm⁻¹ associated to a structural vibration in the aromatic C≡C and anti-symmetric C═O stretch of GO. The sharp bands around 3567 cm⁻¹ could be assigned to OH groups from the Al—OH resulting from the aluminum collector. An obvious shoulder at 2535 cm⁻¹ could be ascribed to the S—H stretching vibration, which suggested the presence of the balance between O—H and S—H.

All references, including publications, patent applications, and patents cited herein are hereby incorporated by reference in their entireties to the same extent as if each reference was individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening.

The recitation of ranges of values herein are merely intended to serve as a shorthand method of referring individually to each separate value falling within the range, unless otherwise indicated herein, and each separate value is incorporated into the specification as if it was individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not impose a limitation on the scope of the invention unless otherwise claimed.

No language in the specification should be construed as indicating any non-claimed element as essential to the practice of the invention.

It will be apparent to those skilled in the art that various modifications and variations can be made to the present invention without departing from the spirit and scope of the invention. There is no intention to limit the invention to the specific form or forms disclosed, but on the contrary, the intention is to cover all modifications, alternative constructions, and equivalents falling within the spirit and scope of the invention, as defined in the appended claims. Thus, it is intended that the present invention cover the modifications and variations of this invention provided they come within the scope of the appended claims and their equivalents.

What is claimed is:

1. A method for preparing a material composition comprising:
combining a reactive carbon material and a sulfur material to form a reactive carbon material-sulfur material composite core material; and
combining the reactive carbon material-sulfur material composite core material with a complementary reactive sheath material to provide a reactive carbon material-sulfur material core material surrounded by and chemically coupled with the complementary reactive sheath material as a shell material.

2. The method of claim 1 wherein the reactive carbon material is selected from the group of materials consisting of chemically functional amorphous carbon materials, chemically functional crystalline carbon materials and chemically functional graphitic carbon materials.

3. The method of claim 1 wherein the reactive carbon material is selected from the group of materials consisting of chemically functional graphite, chemically functional graphene, chemically functional graphene oxide, chemically functional amorphous carbon, chemically functional mesoporous carbon, chemically functional carbon black and chemically functional carbon-tubes.

4. The method of claim 1 wherein the reactive carbon material includes a least one of a hydroxyl functionality and a carboxylic acid functionality.

5. The method of claim 1 wherein the sulfur material is selected from the group consisting of elemental sulfur and sulfide materials.

6. The method of claim 1 wherein the reactive carbon material and the sulfur material are thermally annealed at a temperature from about 50 to about 600 degrees centigrade to form the reactive carbon material-sulfur material alloy core material.

7. The method of claim 1 wherein the reactive carbon material and the sulfur material are thermally annealed at a reactive carbon material:sulfur material weight ratio from about 1:10 to about 2:1 to form the reactive carbon material-sulfur material alloy core material.

8. The method of claim 1 wherein the reactive carbon material:sulfur material composite and the complementary reactive sheath material are reacted in solution to provide the reactive carbon material-sulfur material composite core material surrounded by and chemically coupled with the complimentary reactive sheath material as the shell material.

9. A material composition comprising:
a core material comprising a reactive carbon material-sulfur material composite; and
a shell material comprising a complementary reactive sheath material that surrounds and is chemically coupled with the core material.

10. The material composition of claim 9 wherein:
the reactive carbon material comprises graphene oxide;
the sulfur material comprises elemental sulfur; and
the reactive sheath material comprises amylopectin.

11. The material composition of claim 9 wherein:
the reactive carbon material is selected from the group consisting of chemically functional amorphous carbon materials, chemically functional crystalline carbon materials and chemically functional graphitic carbon materials;
the sulfur material is selected from the group consisting of elemental sulfur and sulfide materials; and
the reactive sheath material is selected from the group consisting of polysaccharide polymer materials, polyalcohol polymer materials, polyamide materials and polycarboxyllic acid polymer materials.

12. The material composition of claim 9 wherein the reactive carbon material-sulfur material composite core material has a reactive carbon material:sulfur material weight ratio from about 1:10 to about 2:1.

13. The material composition of claim 9 wherein the complementary reactive sheath material is chemically coupled to the reactive carbon material-sulfur material composite core material through hydrogen bonding.

14. The material composition of claim 9 wherein the complementary reactive sheath material is chemically coupled with the reactive carbon material-sulfur material composite core material through covalent bonding.

15. The material composition of claim 9 wherein the complementary reactive sheath material is chemically coupled with the reactive carbon material-sulfur material composite core material through ionic bonding.

16. An electrode comprising:
a conductive substrate; and
a material composition located upon the conductive substrate, wherein the material composition comprises:
a core material comprising a reactive carbon material-sulfur material composite; and
a shell material comprising a complementary reactive sheath material that surrounds and is chemically coupled with the core material.

17. The electrode of claim 16 wherein:
the reactive carbon material comprises graphene oxide;
the sulfur material comprises elemental sulfur; and
the reactive sheath material comprises amylopectin.

18. An electrical component comprising an electrode comprising:
a conductive substrate; and
a material composition located upon the conductive substrate, wherein the material composition comprises:
a core component comprising a reactive carbon material-sulfur material alloy; and
a shell component encapsulating the core component and comprising a reactive shell material chemically coupled to the reactive carbon material.

19. The electrical component of claim 18 wherein:
the reactive carbon material comprises graphene oxide;
the sulfur material comprises elemental sulfur; and
the reactive sheath material comprises amylopectin.

20. The electrical component of claim 18 wherein the electrical component is selected from the group consisting of an electrochemical gas sensor, an ultracapacitor and a battery.
